(19) United States
(12) Patent Application Publication
(10) Pub. No.: US 2025/0381545 A1
(43) Pub. Date: Dec. 18, 2025

(54) AMMONIUM NITRATE PRODUCTION

(71) Applicants: KATHOLIEKE UNIVERSITEIT LEUVEN, Leuven (BE); UNIVERSITEIT ANTWERPEN, Antwerpen (BE)

(72) Inventors: Johan MARTENS, Sint-Joris-Weert (BE); Lander HOLLEVOET, Beerse (BE); Annemie BOGAERTS, Wommelgem (BE); Yury GORBANEV, Wilrijk (BE)

(21) Appl. No.: 18/881,200

(22) PCT Filed: Jul. 6, 2023
(86) PCT No.: PCT/EP2023/068758

§ 371 Date: Jan. 3, 2025

(30) Foreign Application Priority Data
Jul. 6, 2022 (EP) 22183224.9
Aug. 5, 2022 (EP) 22189074.2

(51) Int. Cl. B01J 19/08; B01D 53/18; B01D 53/58; B01D 53/78; C01B 21/32; C01B 21/36; C01C 1/18

(52) U.S. Cl. CPC B01J 19/08; B01D 53/18; B01D 53/58; B01D 53/78; C01B 21/32; C01B 21/36; C01C 1/185; B01D 2252/103; B01D 2257/406; B01D 2258/06; B01J 2219/00033; B01J 2219/0869; B01J 2219/0883; B01J 2219/0896

(57) ABSTRACT

The present invention relates generally to an ammonia capture system or method comprising plasma NOx and, more particularly to such system and method for ammonia capture comprising a two-tank NOx absorption system. Furthermore the present invention concerns a system to produce ammonium nitrate in solution or as a solid from atmospheric ammonium.

### FIELD OF THE INVENTION

The present invention relates generally to an ammonia capture system or method comprising plasma NOₓ and, more particularly to such system and method for ammonia capture comprising two liquid loops. Furthermore the present invention concerns a system to produce ammonium nitrate in solution or as a solid from atmospheric ammonium.

Several documents are cited throughout the text of this specification. Each of the documents herein (including any manufacturer's specifications, instructions etc.) are hereby incorporated by reference; however, there is no admission that any document cited is indeed prior art of the present invention.

### DESCRIPTION OF THE RELATED ART

There is a serious problem in the art concerning ammonia (NH₃) emission. The largest share of the emissions of NH₃ originates from livestock farms. Part of the emitted ammonia is precipitated as such, another part is engaged in atmospheric chemistry. In the atmosphere the basic NH₃ molecule reacts with acidic pollutants, such as SOₓ and NOₓ from other sources, to produce ultrafine ammonium sulfate and nitrate salt particles, which act as condensation nuclei for atmospheric water. The resulting droplets form an aerosol which is transported over distances before precipitating on the ground. This chemistry explains how ammonia in combination with other air pollutants becomes a powerful fertiliser precipitating on soils from the atmosphere in an uncontrolled manner.

On the other hand, nitrogen is an essential but quite scarce nutrient in soils, and plants need it for growing. Plants cultivated in agricultural fields and harvested for application as human and animal food or biobased products heavily rely on fertilisers providing specifically N, P and K chemical elements. However, the majority of wild plants are adapted to poor soil and, when enriched by the precipitating atmospheric nitrogen compounds, these plants are outcompeted by species such as nettles, blackberries and grasses, which do just fine in nutrient-rich soil. Only about one quarter of all plants on Earth benefit from N-fertilisers, while for three quarters it is detrimental. This explains why atmospheric nitrogen fertiliser precipitation entails a potential loss of biodiversity.

Several approaches for reducing the impact of ammonia emissions on surrounding ecosystems are implemented. The ‘end-of-pipe’ technologies refer to the purification of air that exits at ventilation openings. The prevailing end-of-pipe technique is the use of air scrubbers. Air scrubbers for eliminating ammonia can be divided in two categories: biological and acid scrubbers. The operation principle of both types is similar. Air is sent over a packed bed above which a water sprinkler is positioned. The finely divided water absorbs ammonia from the air. In a biological scrubber, the absorbed NH₃ is digested by bacteria and converted into a solution of nitrite (NO₂⁻) and subsequently nitrate (NO₃⁻) under aerobic conditions. Some experimental biological scrubbers are equipped with an additional denitrification tank, which converts the nitrates to nitrogen gas (N₂) under anaerobic conditions. The washing water requires a close to neutral pH in order to sustain the bacteria responsible for the conversion process. In an acid scrubber, the pH of the washing water is kept typically at a value of 4-6 by addition of sulfuric acid. Absorption of ammonia from the gas phase causes the pH values of the liquid phase to rise, thus requiring it to be compensated by the addition of an acid.

Acid scrubbers of concentrated sulfuric acid come with additional costs, and the handling requires training and implies severe safety risks. Furthermore, the liquid product of acid scrubbers is a dilute solution of ammonium sulphate, which is a low concentration of N-nutrients and therefore low nutritional value. Biological scrubbers are less efficient at capturing ammonia. They are also less reliable as the biological conversion of captured ammonia can be disrupted by changes in the operation conditions. The concentration of N-nutrients in the liquid product tends to be lower for biological scrubbers than for acid scrubbers.

Thus, there is a need in the art for a reliable NH₃ scrubbing system which does not require the external supply of hazardous chemicals, efficiently removes NH₃ emissions from the gas phase, and produces a product with a high concentration of N-nutrients.

The proposed invention solves these problems by in-situ generation of nitric acid (HNO₃) by reacting NOₓ gasses with an aqueous solution in a gas-liquid contactor (e.g. an absorption column). Acids combine with ammonia to form a solution of ammonium nitrate. Due to the high solubility and high N-content of these salts, the resulting product has a high concentration of N-nutrients. The ammonium nitrate and possibly ammonium nitrite salts can be precipitated to produce a solid product.

### SUMMARY OF THE INVENTION

The present invention solves the problems of the related art by using an inventive system comprising two liquid loops: one loop with a gas-liquid contactor where a gas comprising NOₓ is brought into contact with an aqueous solution, producing an aqueous solution of nitric acid, and one loop with a gas-liquid contactor where a gas comprising NH₃ is brought into contact with an aqueous solution comprising nitric acid to produce ammonium nitrate. By using two separate liquid loops, the pH of each liquid loop can be controlled separately.

The liquid loop which produces nitric acid can be operated under atmospheric or near atmospheric pressure (<1 bar overpressure) or increased overpressure (1-10 bar and preferably 3-7 bar) in the gas-liquid contactor (I) by which it is possible to achieve several advantages. First of all, higher pressure allows a larger amount of gas to be present in the gas-liquid contactor, which increases residence time and conversion for the same volume of gas-liquid contactor. Furthermore, the higher pressure significantly increases the rate of the oxidation of NO to NO₂, which has a 3^{rd} order dependency on the total pressure. As this oxidation of NO to NO₂ is the rate limiting step for NOₓ absorption, the NOₓ conversion into acid is increased. Finaly, the increased pressure also increases the solubility of NOₓ gases into the liquid, accelerating the absorption process. However, the use of increased pressure also requires additional pressure equipment and for the plasma reactor and gas liquid contactor to withstand this pressure. Therefore, a gas-liquid contactor at atmospheric or near atmospheric pressure (less than 1 bar overpressure), which achieves less conversion for the same size or requires a larger size than a pressurised gas-liquid contactor for the same conversion, can still be the preferred option.

According to the present invention there is provided the use of a separate high pressure (1-10 bar and preferably 3-7 bar overpressure) liquid loop or atmospheric or near atmospheric pressure loop (less than 1 bar overpressure), comprising a gas-liquid contactor (I), the first buffer tank (M), pump (O) and streams (N) and (L) to feed the gas-liquid contactor and a second separate low pressure (<1 bar overpressure) loop, comprising an air scrubbing unit (T), the second buffer tank (W) and streams (V), (Y), (Q) and(S); this has several advantages compared to a single loop and buffer tank. First of all, the pressure increase from the first buffer tank (M) to the gas-liquid contactor (I) is minimized, which decreases the energy cost. Furthermore, this configuration allows the possibility to maintain a lower pH in the first high pressure or atmospheric or near atmospheric pressure loop and first buffer tank (M) than in the low pressure loop and second buffer tank (W). As the selectivity of NOₓ conversion to HNO₃ increases with lower pH, the desired ratio of NO₃⁻ vs NO₂₋ can be obtained by altering the pH in the high pressure or atmospheric or near atmospheric pressure loop. This pH can be lowered by lowering the flowrate of the streams (X) and (P) or increased by increasing the flowrate of the streams (X) and (P).

In one embodiment of the present invention there is provided using oxygen enriched air (D) with an O₂/N₂ ratio of 2-3 and preferably 2.3-2.7 as feed for the gas loop which contains the plasma reactor (G), gas-liquid contactor (I) and streams (C), (F), (J) and (H); this has several advantages compared to using air with a O₂/N₂ ratio of 21/78. First of all, it allows the plasma reactor (G) to operate under an optimized N₂/O₂ ratio, which increases the concentration of NOₓ that is generated and increases the energy efficiency of the plasma reactor. Furthermore, the increased oxygen concentration in the gas-liquid contactor (I) accelerates the oxidation of NO to NO₂ (Eq. ₂). The reaction rate of this reaction has a first order dependency on the oxygen concentration. Finally, the stoichiometric O₂/N₂ ratio for HNO₃ production is 2.5. Because the O₂/N₂ ratio of stream (D) is close to this value, it allows extensive recycling of the gaseous output of the gas-liquid contactor (I). Because of this recycling, the emission of unconverted NOₓ is strongly reduced, less energy is required for compression of the feed gas and less oxygen enriched air needs to be generated, making the concept more efficient.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description. It is to be understood that both the foregoing general description and the following detailed description are exemplary and explanatory only and are not restrictive of the invention, as claimed.

In a certain aspect of present invention ammonia is removed by sending ammonia comprising air, for instance the stable air, through an air scrubber (T) for instance an air scrubber with a porous material bed with water sprinklers above. The material bed ensures a large contact area. The ammonia is absorbed by the water, where it functions as a weak base (pKa=9.25). This results in the conversion of volatile NH₃ into highly soluble NH₄⁺, as shown in eq. 1. The water is slightly acidic (pH 3-6.9) to shift the equilibrium to the NH₄⁺ side.

$${NH}_{3} ( g ) + {H}^{+} ( aq ) ⇌ {NH}_{4}^{+} ( aq ) \qquad ( Eq . 1 )$$

This air scrubber (T) has a gas input for receiving ammonia containing gas for instance air from an animal stable. The air scrubber has an output for liquid connected with an input into a buffer tank (W) to collect such ammonia enriched water from the air scrubber and to buffer it to a pH of 3 to 6.9. This is because the consumption of protons by ammonium formation increases the pH of the water, which then shifts the equilibrium back to the NH₃ side of Eq. 1 and diminishes the driving force for the absorption of airborne NH₃. The increase in pH caused by the conversion of NH₃ to NH₄⁺ therefore needs to be compensated by the addition of an acid. A liquid guidance from the buffer tank provided with a pump connects with an input of the air scrubber to recycle liquid into the air scrubber (T) transversal on the ammonia comprising gas stream. In present invention this reactor assembly or production system is described as the second recirculation unit.

In certain embodiments of the present invention, nitric acid (HNO₃) and nitrous acid (HNO₂) are generated inside the process in a series of steps. First, air is fed to a compressor (A) to achieve an overpressure of 1-11 bar and preferably 3-7 bar. Next, the compressed air (B) is sent to an air separation unit (C) (e.g. membrane separation or pressure swing adsorption) which generates oxygen enriched air (D) with an O₂/N₂ ratio of 2-3 and preferably 2.3-2.7 and an overpressure of 1-10 bar and preferably 3-8 bar or alternatively at atmospheric or near atmospheric pressure (<1 bar overpressure).

The production systems or reactor assembly of present invention is connected with plasma reactor (G) or comprises a NOₓ generator comprising an upstream air seperation unit (C) and a downstream plasma reactor (G).

In another embodiment of the invention, air is sent directly to the plasma reactor at atmospheric or near-atmospheric pressure (<1 bar overpressure) without upstream air separation to obtain oxygen enriched air. This way the previously mentioned benefits of using oxygen enriched air are not applicable, but no air separation equipment is required, making implementing the invention less complex.

The NOₓ of present invention is from a plasma reaction, the NOₓ generator comprises an air input that is fluidly connected with an air separation unit (C) where through the air passes so that it becomes oxygen enriched air; the output of the air separator unit (C) is fluidly connected for instance by a gas guidance with an input of the plasma reactor (G). Or alternatively, the air is fed to the plasma reactor (G) without passing throug an upstream air separation unit. Optionally a gas output from a gas-liquid contactor (I) from a first recirculation unit, for instance via a gas guidance, fluidly connects with the gas guidance from the air separation unit (C) to the plasma reactor (G). Air input that fluidly connects with an air separator unit (C) can be forseen with a gas displacement device (e.g. compressor or fan). Next, the pressurized oxygen-enriched air or oxygen-enriched air at atmospheric or near atmospheric pressure (<1 bar overpressure) can be mixed with the recirculated gas coming from the gas-liquid contactor (E), which comprises N₂, O₂ and possibly NOₓ. The resulting gas mixture (F) has an O₂/N₂ ratio of 0.4-2.5 and an overpressure of 1-10 bar and preferably 3-7 bar or alternatively atmospheric or near atmospheric pressure (<1 bar overpressure) and is fed to a plasma reactor (G), where it is partly converted to NOₓ (NO₂ and NO), according to eq. 2 and 3, with a NOₓ concentration of 1-10%.

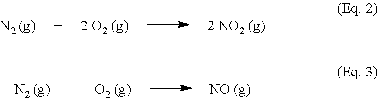

The NOx generator fluidly by or after its plasma reactor (G) connects with gas-liquid contactor (I) of the first recirculation unit so that NOₓ containing gas (H) is sent to a gas-liquid contactor (I). In the gas-liquid contactor (I) the gas is brought into contact with an acidic aqueous solution (pH 1-6), which can comprise NH₃, NH₄⁺, NO₃ and NO₂⁻. A gas output of the gas-liquid contactor (I) can be fluidly connected with the NOₓ generator.

The NOₓ generator comprises a plasma reactor (G). The gas output of the gas-liquid contactor (I) can be fluidly connected with the gas guidance (D) which feeds oxygen enriched air to the NOₓ generator, and gas guidance (F), which feeds the mixture of the gasses to the plasma reactor (G). This way remaining gas (J), comprising N₂, O₂ and possibly some NOₓ, can be recirculated, for instance driven by a fan or compressor. The majority (>75%) (E) of the recirculated gasses can be mixed with oxygen enriched air (D) and the mixed stream (F) can be fed back to the plasma reactor (G). A small share (<25%) (K) of the recirculated gas can be purged to avoid the accumulation of inert or unwanted species such as argon.

The gas-liquid contactor (I) of the first recirculation unit is fluidly connected with an input of a buffer tank (M). This buffer tank (M) is preferably under an overpressure of 1-10 bar and more preferably 3-7 bar or alternatively at atmospheric or near atmospheric pressure (>1 bar overpressure). This way liquid stream (L) coming from the gas-liquid contactor (I) is sent to this buffer tank (M) preferably with an overpressure of 1-10 bar and more preferably 3-7 bar or alternatively at atmospheric or near atmospheric pressure (<1 bar overpressure). This buffer tank (M) is with an output fluidly connected with absorption column (I), so that a share (N) of the aqueous solution in this buffer tank (M) can be fed back to the gas-liquid contactor by a liquid pump (O). The buffer tank (M) is with another output fluidly connected with a liquid stream guidance from the output of a buffer tank (W) from the second recirculation unit, so that another share (P) of the aqueous solution is mixed with another liquid stream (Q) which operates at atmospheric or near atmospheric pressure (overpressure 21 1 bar). A small share (<10%) (R) of this liquid stream is drained via an output of this second recirculation system.

Some embodiments of the invention are set forth in claim format directly below:
1. A system for production of an ammonium nitrate and/or ammonium nitrite solution or solid from a ammonium comprising gas, comprising
i) a NOx generator with one or more oxygen enriched air streams and under pressure of 1-10 bar or alternatively at atmospheric or near atmospheric pressure (<1 bar overpressure) that passed through a plasma reactor
ii) an aqueous fluid recirculation unit comprising a gas-liquid contactor and a liquid pump operating under atmospheric pressure or near atmospheric pressure (overpressure<1 bar) and a slightly acidic pH of 3 to 6.9 to capture ammonia from an ammonia comprising gas into an aqueous stream comprising nitric acid and/or nitrous acid to produce ammonium nitrate and/or ammonium nitrite.
iii) an aqueous fluid recirculation unit comprising a gas-liquid contactor and a liquid pump to produce nitric acid and/or nitrous acid whereby the aqueous fluid under a pH of 1 to 6 with intake in the unit of NOx from the NOx generator and intake in the unit of aqueous fluid from the other aqueous fluid recirculation unit.
2. The system according to embodiment 1, whereby the NOx generator is supplied with one or more gas streams comprising N₂ and O₂ with a combined O₂/N₂ ratio of 2-3.
3. The system according to embodiment 1, whereby the NOx generator is supplied with one or more gas streams comprising N₂ and O₂ with a combined O₂/N₂ ratio of 2.3-2.7.
4. The system according to embodiment 1, whereby the NOx is supplied with one or more gas streams comprising N₂ and O₂ with a combined O₂/N₂ ratio of 2.3-2.7 and under pressure of 3-8 bar that passed through a plasma reactor.
5. The system according to any one of the embodiments 1 to 4, whereby the oxygen enriched air stream from the NOx generator takes up a gas stream from the aqueous fluid recirculation unit of the nitric acid and/or nitrous acid production unit (iii).
6. The system according to any one of the embodiments 1 to 5, for continuous production of an ammonium nitrate and/or ammonium nitrite solution or solid from a ammonium comprising gas, comprising
i) the NOx generator
ii) an aqueous fluid recirculation unit comprising a gas-liquid contactor and a liquid pump operating under atmospheric pressure or near atmospheric pressure (overpressure <1 bar) and a slightly acidic pH of 3 to 6.9 to capture ammonia from an ammonia comprising gas into an aqueous stream comprising nitric acid and/or nitrous acid to produce ammonium nitrate and/or ammonium nitrite.
iii). an aqueous fluid recirculation unit comprising a gas-liquid contactor and a liquid pump to produce nitric acid and/or nitrous acid whereby the aqueous fluid under a pH of 1 to 6 with intake in the unit of NOx from the NOx generator and intake in the unit of aqueous fluid comprising ammonium nitrate and/or ammonium nitrite and/or nitric acid and/or nitrous acid from the other aqueous fluid recirculation unit.
7. The system according to any one of the embodiments 1 to 5, whereby the nitric acid and/or nitrous acid production unit (iii) is under increased pressure of 1-10 bar.
8. The system according to any one of the embodiments 1 to 5, whereby the nitric acid and/or nitrous acid production unit (iii) is under increased pressure of 3-7 bar.
9. The system according to any one of the embodiments 1 to 5, whereby the aqueous fluid comprising a dissolved ammonium nitrate and/or ammonium nitrite salt and a nitric acid or nitrous acid or combination thereof.
10. The system according to any one of the embodiments 1 to 9, whereby the ammonium nitrate and/or ammonium nitrite end product is in an aqueous solution.
11. The system according to any one of the embodiments 1 to 9, whereby the ammonium nitrate and/or ammonium nitrite end product is a solid.

Some embodiments of the invention are set forth in claim format directly below:
1. A system for production of an ammonium nitrate and/or ammonium nitrite solution or solid from a ammonium comprising gas, comprising
i) a NOx generator comprising a source of oxygen enriched air (D) fluidly connected to a plasma reactor (G), whereby the plasma reactor (G) is fluidly connected to the second aqueous fluid recirculation unit
ii) the first aqueous fluid recirculation unit comprising a gas-liquid contactor and a liquid pump operating under atmospheric pressure or near atmospheric pressure (overpressure<1 bar) and a slightly acidic pH of 3 to 6.9 to capture ammonia from an ammonia comprising gas into an aqueous stream comprising nitric acid and/or nitrous acid to produce ammonium nitrate and/or ammonium nitrite.
iii) a second aqueous fluid recirculation unit comprising a gas-liquid contactor and a liquid pump to produce nitric acid and/or nitrous acid whereby the aqueous fluid under a pH of 1 to 6 with intake in the unit of NOx from the NOx generator and intake in the unit of aqueous fluid from the other aqueous fluid recirculation unit.
2. The system according to embodiment 1, whereby the NOx generator comprising a plasma reactor and operating under an overpressure of 1-10 bar.
3. The system according to embodiment 1, whereby the NOx generator comprising a plasma reactor fed with a mixture of one or more N₂ and/or O₂ comprising gas streams with a combined O₂/N₂ ratio of 2-3, and N₂ and O₂ comprising recirculated gas coming from the gas outlet of the fluid recirculation unit (iii) with an O₂/N₂ ratio of 0.4-2.5. so that the mixture fed to the plasma reactor also has an O₂/N₂ ratio of 0.4-2.5.
4. The system according to embodiment 1, whereby the NOx generator comprising a plasma reactor fed with a mixture of one or more N₂ and/or O₂ comprising gas streams with a combined O₂/N₂ ratio of 2.3-2.7, and N₂ and O₂ comprising recirculated gas coming from the gas outlet of the fluid recirculation unit (iii) with an O₂/N₂ ratio of 0.4 -2.5 so that the mixture fed to the plasma reactor also has an O₂/N₂ ratio of 0.4-2.5
5. The system according to embodiment 1, whereby the NOx generator comprising a plasma reactor fed with a mixture of one or more N₂ and/or O₂ comprising gas streams with a combined O₂/N₂ ratio of 2.3-2.7, and N₂ and O₂ comprising recirculated gas coming from the gas outlet of the fluid recirculation unit (iii) with an O₂/N₂ ratio of 0.4 -2.5 so that the mixture fed to the plasma reactor also has an O₂/N₂ ratio of 0.4-2.5 and under pressure of 1-10 bar that passed through a plasma reactor.
6. The system according to embodiment 1, whereby the NOx generator comprising a plasma reactor fed with a mixture of one or more N₂ and/or O₂ comprising gas streams with a combined O₂/N₂ ratio of 2.3-2.7, and N₂ and O₂ comprising recirculated gas coming from the gas outlet of the fluid recirculation unit (iii) with an O₂/N₂ ratio of 0.4 -2.5 so that the mixture fed to the plasma reactor also has an O₂/N₂ ratio of 0.4-2.5 and under pressure of 3-8 bar that passed through a plasma reactor.
7. The system according to any one of the embodiments 1 to 6, for continuous production of an ammonium nitrate and/or ammonium nitrite solution or solid from a ammonium comprising gas, comprising
   i) the NOx generator comprising an air separation unit (C) fluidly connected with a plasma reactor (G)
   ii) the first aqueous fluid recirculation unit comprising a gas-liquid contactor and a liquid pump operating under atmospheric pressure or near atmospheric pressure (overpressure<1 bar) and a slightly acidic pH of 3 to 6.9 to capture ammonia from an ammonia comprising gas into an aqueous stream comprising nitric acid and/or nitrous acid to produce ammonium nitrate and/or ammonium nitrite.
   iii) the second aqueous fluid recirculation unit comprising a gas-liquid contactor and a liquid pump to produce nitric acid and/or nitrous acid whereby the aqueous fluid under a pH of 1 to 6 with intake in the unit of NOx from the NOx generator and intake in the unit of aqueous fluid comprising ammonium nitrate and/or ammonium nitrite and/or nitric acid and/or nitrous acid from the other aqueous fluid recirculation unit.
8. The system according to any one of the embodiments 1 to 7, whereby the nitric acid and/or nitrous acid production unit (iii) is under increased pressure of 1-10 bar.

9. The system according to any one of the embodiments 1 to 7, whereby the nitric acid and/or nitrous acid production unit (iii) is under increased pressure of 3-7 bar.

10. The system according to any one of the embodiments 1 to 7, whereby the aqueous fluid comprising a dissolved ammonium nitrate and/or ammonium nitrite salt and a nitric acid or nitrous acid or combination thereof.

11. The system according to any one of the embodiments 1 to 7, whereby the ammonium nitrate and/or ammonium nitrite end product is in an aqueous solution.

12. The system according to any one of the embodiments 1 to 7, whereby the ammonium nitrate and/or ammonium nitrite end product is a solid.

Some other embodiments of the invention are set forth in claim format directly below:
1. An apparatus for production of an ammonium nitrate and/or ammonium nitrite solution or solid from a ammonium comprising gas, characterized that
the apparatus comprises i) a NOx generator comprising a source of air or oxygen enriched air (D) fluidly connected to a plasma reactor (G), whereby the plasma reactor (G) is fluidly connected to ii) a first fluid recirculation unit which is fluidly connected with iii) a second fluid recirculation unit
whereby the first fluid recirculation unit comprising 1) gas-liquid contactor (I), 2) a gas stream inlet guidance from the NOx generator at the gas-liquid contactor (I), 3) a buffer unit (M), 4) a liquid pump (O) between the buffer unit (M) and the gas-liquid contactor (I) and 5) a liquid stream inlet from the second fluid recirculation unit
whereby the second fluid recirculation unit comprising 1) a gas-liquid contactor (T). 2) a gas stream inlet at the gas-liquid contactor (T), 3) a buffer unit (W) 4) an atmospheric pressure or near atmospheric pressure (overpressure<1 bar) pump between the buffer unit (W) and the gas-liquid contactor (T).
2. The apparatus for production of an ammonium nitrate and/or ammonium nitrite solution or solid from a ammonium comprising gas according to embodiment 1, characterized that
the apparatus comprises i) a NOx generator comprising a source of air or oxygen enriched air (D) fluidly connected to a plasma reactor (G), whereby the plasma reactor (G) is fluidly connected to ii) a first fluid recirculation unit for producing nitric acid and/or nitrous acid which is fluidly connected with iii) a second fluid recirculation unit to capture ammonia from an ammonia comprising gas into an aqueous stream comprising nitric acid and/or nitrous acid to produce ammonium nitrate and/or ammonium nitrite
whereby the first fluid recirculation unit comprising 1) gas-liquid contactor (I), 2) a gas stream inlet guidance from the NOx generator at the gas-liquid contactor (I), 3) a buffer unit (M) for maintaining the aqueous stream of the first fluid recirculation unit slightly acidic pH of 1 to 6, 4) a liquid pump (O) between the buffer unit (M) and the gas-liquid contactor (I) and 5) a liquid stream inlet from the second fluid recirculation unit
whereby the second fluid recirculation unit comprising 1) a gas-liquid contactor (T). 2) a gas stream inlet at the gas-liquid contactor (T), 3) a buffer unit (W) for maintaining the aqueous stream of the second fluid recirculation unit slightly acidic pH of 3 to 6.9, 4) an atmospheric pressure or near atmospheric pressure (overpressure<1 bar) pump between the buffer unit (W) and the gas-liquid contactor (T).
3. A apparatus according to any one of the embodiments 1 to 2, whereby the oxygen enriched air source comprises an air intake comprised in or fluidly connected to gas pump (A), which gas pump (A) is fluidly connected, for instance by a guidance (B) with the air separation unit (C), which is fluidly connected, for instance by a guidance (D) or (D & F), to the plasma reactor (G).
4. The apparatus according to any one of the embodiments 1 to 2, whereby in the NOx generator comprises an air intake comprised in or fluidly connected to an upstream gas pump (A), which gas pump (A) is fluidly connected, for instance by a guidance (B) downstream with the air separation unit (C), which is fluidly connected, for instance by a guidance (D) or (D & F), further downstream to the plasma reactor (G).
5. The apparatus according to any one of the embodiments 1 to 4, whereby 1) the NOx generator has a fluid outlet into a fluid inlet of a first fluid recirculation, 2) the first recirculation unit has a fluid outlet into a fluid inlet of a second recirculation unit and 3) the second recirculation unit has a fluid outlet back into a fluid inlet of the first fluid recirculation unit.
6. The apparatus according to any one embodiments 1 to 4, whereby the NOx generator comprising a plasma reactor (G) and passing the product of the plasma reactor into the gas-liquid contactor (I) of the first recirculation unit
7. The apparatus according to any one embodiments 1 to 4, whereby the NOx generator comprises a plasma reactor (G) operating under an overpressure of 1-10 bar.

8. The apparatus according to any one embodiments 1 to 4, whereby the NOx generator comprising a plasma reactor (G) fed with a mixture of one or more N₂ and/or O₂ comprising gas streams with a combined O₂/N₂ ratio of 2-3, and N₂ and O₂ comprising recirculated gas coming from the gas outlet of the fluid recirculation unit (ii) with an O₂/N₂ ratio of 0.4-2.5. The mixture fed to the plasma reactor also has an O₂/N₂ ratio of 0.4-2.5.
9. The apparatus according to any one embodiments 1 to 7, whereby the NOx generator comprising a plasma reactor (G) fed with a mixture of one or more N₂ and/or O₂ comprising gas streams with a combined O₂/N₂ ratio of 2.3-2.7, and N₂ and O₂ comprising recirculated gas coming from the gas outlet of the fluid recirculation unit (ii) with an O₂/N₂ ratio of 0.4-2.5. The mixture fed to the plasma reactor also has an O₂/N₂ ratio of 0.4-2.5.
10. The apparatus according to any one embodiments 1 to 7, whereby the NOx generator comprising a plasma reactor (G) fed with a mixture of one or more N₂ and/or O₂ comprising gas streams with a combined O₂/N₂ ratio of 2.3-2.7, and N₂ and O₂ comprising recirculated gas coming from the gas outlet of the fluid recirculation unit (ii) with an O₂/N₂ ratio of 0.4-2.5. The mixture fed to the plasma reactor also has an O₂/N₂ ratio of 0.4-2.5 and under pressure of 1-10 bar that passed through a plasma reactor.
11. The apparatus according to any one embodiments 1 to 7, whereby the NOx generator comprising a plasma reactor (G) fed with a mixture of one or more N₂ and/or O₂ comprising gas streams with a combined O₂/N₂ ratio of 2.3-2.7, and N₂ and O₂ comprising recirculated gas coming from the gas outlet of the fluid recirculation unit (ii) with an O₂/N₂ ratio of 0.4-2.5. The mixture fed to the plasma reactor also has an O₂/N₂ ratio of 0.4-2.5 and under pressure of 3-8 bar that passed through a plasma reactor.
12. The apparatus according to any one of the embodiments 1 to 11, whereby the gas-liquid contactor (I) of the first fluid recirculation unit is an absorption column.
13. The apparatus according to any one embodiments 1 to 12, whereby the gas-liquid contactor (T) of the second fluid recirculation unit is an air scrubber.
14. The apparatus according to any one of the embodiments 1 to 13, whereby the pressure and flowrate of the gas inlet and outlet of the gas-liquid contactor (I) of the first recirculation unit is adapted to maintain the increased pressure of 1-10 bar.

15. The apparatus according to any one of the embodiments 1 to 13, whereby the pressure and flowrate of the gas inlet and outlet of the and the gas-liquid contactor (I) of the first recirculation unit is adapted to maintain the pressure increased pressure of pressure of 3-7 bar.
16. The apparatus according to any one embodiments 1 to 15, for continuous production of an ammonium nitrate and/or ammonium nitrite solution or solid from an ammonium comprising gas.

17. The apparatus according to any one embodiments 1 to 16, for the production of ammonium nitrate and/or ammonium nitrite end product in an aqueous solution.

18. The apparatus according to any one embodiments 1 to 16, for the production of ammonium nitrate and/or ammonium nitrite end product as a solid.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 provides a schematic overview of one embodiment of the system of present invention; and

FIG. 2 provides a schematic overview of another embodiment of the system of present invention.

### DETAILED DESCRIPTION OF EMBODIMENTS OF THE INVENTION

The following detailed description of the invention refers to the accompanying drawings. The same reference numbers in different drawings identify the same or similar elements. Also, the following detailed description does not limit the invention. Instead, the scope of the invention is defined by the appended claims and equivalents thereof.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to the devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Other embodiments of the invention will be apparent to those skilled in the art from consideration of the specification and practice of the invention disclosed herein.

It is intended that the specification and examples be considered as exemplary only.

Each and every claim is incorporated into the specification as an embodiment of the present invention. Thus, the claims are part of the description and are a further description and are in addition to the preferred embodiments of the present invention. Each of the claims set out a particular embodiment of the invention.

The following terms are provided solely to aid in the understanding of the invention.

The terms “about” or “approximately” are defined as being close to as understood by one of ordinary skill in the art. In one non-limiting embodiment the terms are defined to be within 10%, preferably, within 5%, more preferably, within 1%, and most preferably, within 0.5%.

The terms “wt. %,” “vol. %” or “mol. %” refer to a weight, volume, or molar percentage of a component, respectively, based on the total weight, the total volume, or the total moles of material that includes the component. In a non-limiting example, 10 moles of component in 100 moles of the material is 10 mol. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification, include any measurable decrease or complete inhibition to achieve a desired result.

The term “effective,” as that term is used in the specification and/or claims, means adequate to accomplish a desired, expected, or intended result.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process of the present invention can “comprise,” “consist essentially of,” or “consist of” particular ingredients, components, compositions, etc., disclosed throughout the specification.

The term “primarily,” as that term is used in the specification and/or claims, means greater than any of 50 wt. %, 50 mol. %, and 50 vol. %. For example, “primarily” may include 50.1 wt. % to 100 wt. % and all values and ranges there between, 50.1 mol. % to 100 mol. % and all values and ranges there between, or 50.1 vol. % to 100 vol. % and all values and ranges there between.

Any convenient type of air separation can be used, such as cryogenic separation, membrane separation, absorption separation, and/or adsorption (including swing adsorption).

The words “a pressure of” or “an overpressure of” relate to the pressure level relative to the atmospheric pressure.

The air in stables needs to be refreshed constantly to meet with regulations and keep the concentration of pollutants such as ammonia below a critical value. If the air coming from the stables would be vented to the environment without further treatment, the ammonia emissions would disturb nearby eco-systems. Therefore, regulations require ammonia to be removed from the air.

By present invention ammonia is removed by sending ammonia enriched air, for instance the stable air, through a porous material bed with water sprinklers above. The material bed ensures a large contact area. The ammonia is absorbed by the water, where it functions as a weak base (pKa=9.25). This results in the conversion of volatile NH₃ into highly soluble NH₄⁺, as shown in eq. 1. The water is slightly acidic (pH 3-6.9) to shift the equilibrium to the NH₄⁺ side.

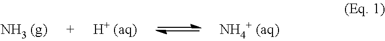

The consumption of protons by ammonium formation increases the pH of the water, which then shifts the equilibrium back to the NH₃ site and diminishes the driving force for the absorption of airborne NH₃. The increase in pH caused by the conversion of NH₃ to NH₄⁺therefore needs to be compensated by the addition of an acid.

With present invention, nitric acid (HNO₃) and nitrous acid (HNO₂) are generated inside the process in a series of steps. In one embodiment, air is first fed to a compressor (A) to achieve an overpressure of 1-11 bar and preferably 3-7 bar. Next, the compressed air (B) is sent to an air separation unit (C) (e.g. membrane separation or pressure swing adsorption) which generates oxygen enriched air (D) with an O₂/N₂ ratio of 2-3 and preferably 2.3-2.7 and an overpressure of 1-10 bar and preferably 3-8 bar.

Next, the pressurized oxygen enriched air is mixed with the recirculated gas coming from the gas-liquid contactor (E), which comprises N₂, O₂ and possibly NOₓ. The resulting gas mixture (F) has an O₂/N₂ ratio of 0.4-2.5 and is fed to a plasma reactor (G), where it is partly converted to NOₓ (NO₂ and NO), according to eq. 2 and 3, with a NOₓ concentration of 1-10%.

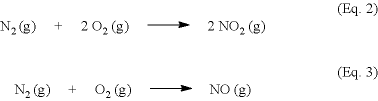

In another embodiment, which does not make use of oxygen enriched air, the air is fed directly to the plasma reactor (G), where it is partly converted to NOₓ (NO₂ and NO), according to eq. 2 and 3, with a NOₓ concentration of 1-10%.

Next, the NOₓ containing gas (H) is sent to an gas-liquid contactor (I) where the gas is brought into contact with an acidic aqueous solution (pH 1-6), which can comprise NH₃, NH₄⁺, NO₃⁻ and NO₂⁻. The reactions shown in equation 4-15 take place inside the adsorption column.

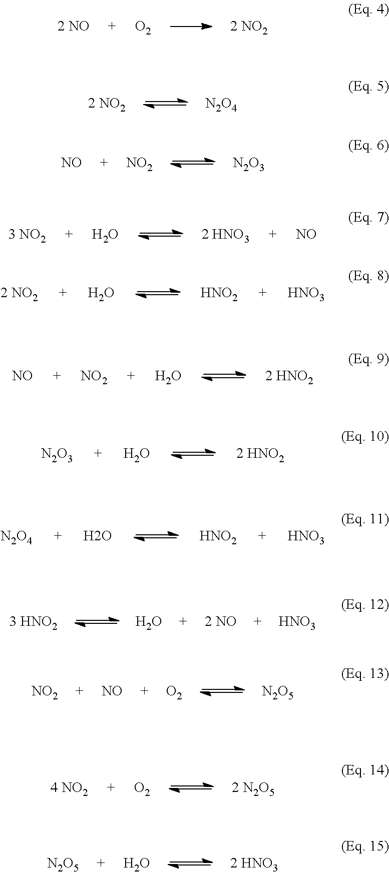

Combined, Eq. 4-15 result in the conversion of NOₓ into HNO₂ and HNO₃. The ratio of HNO₃/HNO₂ is determined by the pH of the aqueous solution, with a lower pH resulting in a higher selectivity towards HNO₃. The rate limiting reaction is given by Eq. 4.

The adsorption column removes >75%, and preferably >90% of NOₓ out of the gas phase. In one embodiment of the invention, the remaining gas (J), comprising N₂, O₂ and possibly some NOₓ, is recirculated by a fan or compressor (K). The majority (22 75%) (E) of the recirculated gasses is mixed with oxygen enriched air (D) and the mixed stream (F) is fed back to the plasma reactor (G). A small share (<25%) (K) of the recirculated gas is purged to avoid the accumulation of inert or unwanted species such as argon. In another embodiment of the invention, the gas stream J, comprising N₂, O₂ and possibly some NOₓ is vented to the atmosphere instead of being recirculated.

The liquid stream (L) coming from the gas-liquid contactor (I) is sent to a first buffer tank (M) with an overpressure of 1-10 bar and preferably 3-7 bar or alternatively atmospheric or near atmospheric pressure (<1 bar overpressure). A share (N) of the aqueous solution in the first buffer tank (M) is fed back to the gas-liquid contactor by a liquid pump (O). Another share (P) of the aqueous solution is mixed with another liquid stream (Q) which operates at atmospheric or near atmospheric pressure (overpressure<1 bar). A small share (<10%) (R) of this liquid stream is drained. The remaining share(S) can be mixed with a stream of water (>95 wt % H₂O) before it is sent to an air scrubbing unit (T). Inside the air scrubbing unit (T), the aqueous solution (pH 3-6.9) is brought into contact with air containing gaseous NH₃ (1-100 ppm). The ammonia is absorbed into the aqueous solution. This removes >70% and preferably >90% of NH₃ out of the gas phase. The purified gas stream is vented to the atmosphere. The liquid coming from the gas scrubber (V) is an aqueous solution comprising NH₄⁺, NH₃, NO₃⁻ and NO₂⁻ with a pH of 3-6.9.This liquid is sent to a second buffer tank (W), which operates at atmospheric or near atmospheric pressure (<1 bar overpressure). Some of the liquid (X) from the second buffer tank is pumped to and mixed with the stream (N) coming from the first buffer tank. The mixed stream has an overpressure pressure of 1-10 bar and preferably 3-7 bar. Another share of the liquid (Y) coming from the second buffer tank (W) is mixed with another stream (P) coming from the other tank (M). The mixed stream (Q) operates at atmospheric or near atmospheric pressure (overpressure<1 bar).

Optionally, ammonium nitrate and/or ammonium nitrite can be precipitated out of the liquid product (R) by cooling of the aqueous solution, which lowers the solubility of the dissolved ammonium nitrate and ammonium nitrite. The remaining aqueous solution, which has decreased concentration of dissolved ammonium nitrite and ammonium nitrate (<25 wt %) can be fed back to the air scrubber through stream (Z).

The invention described herein is based on inventive insights of the inventors and produces technical effects and advantages of the prior art, as non-limitingly described hereinbelow:
The embodiments which use increased overpressure pressure (1-10 bar and preferably 3-7bar) in the gas-liquid contactor (I) have several advantages. First of all, higher pressure allows a larger amount of gas to be present in the gas-liquid contactor, which increases residence time and conversion for the same volume of gas-liquid contactor. Furthermore, the higher pressure significantly increases the rate of the oxidation of NO to NO₂, which has a 3th order dependency on the total pressure. As this is the rate limiting step for NOₓ absorption, the NOₓ conversion is increased. Finaly, the increased pressure also increases the solubility of NOₓ gases into the liquid, accelerating the absorption process.

The embodiments which use atmospheric or near atmospheric pressure (21 1 bar overpressure) have the advantage that the equipment does not need to be designed to withstand higher pressures.

The use of a separate high pressure (1-10 bar and preferably 3-7 bar overpressure) or alternatively atmospheric or near atmospheric pressure (<1 bar overpressure) liquid loop, comprising an gas-liquid contactor (I), the first buffer tank (M), pump (O) and streams (N) and (L) to feed the gas-liquid contactor and a separate low pressure (<1 bar overpressure) loop, comprising an air scrubbing unit (T), the second buffer tank (W) and streams (V), (Y), (Q) and(S) has several advantages compared to a single loop and buffer tank. First of all, the pressure increase from the first buffer tank (M) to the gas-liquid contactor (I) is minimized, which decreases the energy cost. Furthermore, this configuration allows the possibility to maintain a lower pH in the high pressure loop and first buffer tank (M) than in the low pressure loop and second buffer tank (W). As the selectivity of NOₓ conversion to HNO₃ increases with lower pH, the disired ratio of NO₃⁻ vs NO₂⁻ can be obtained by altering the pH in the high pressure loop. This pH can be lowered by lowering the flowrate of the streams (X) and (P) or increased by increasing the flowrate of the streams (X) and (P)

Using oxygen enriched air (D) with an O₂/N₂ ratio of 2-3 and preferably 2.3-2.7 as feed for the gas loop which contains the plasma reactor (G), gas-liquid contactor (I) and streams (E), (F), (J) and (H) has several advantages compared to using air with a O₂/N₂ ratio of 21/78. First of all, it allows the plasma reactor (G) to operate under an optimized N₂/O₂ ratio, which increases the concentration of NOₓ that is generated and increases the energy efficiency of the plasma reactor. Furthermore, the increased oxygen concentration in the gas-liquid contactor (I) accelerates the oxidation of NO to NO₂ (Eq. 2). The reaction rate of this reaction has a first order dependency on the oxygen concentration. Finally, the stoichiometric O₂/N₂ ratio for HNO₃ production is 2.5. Because the O₂/N₂ ratio of stream (D) is close to this value, it allows extensive recycling of the gaseous output of the gas-liquid contactor (I). Because of this recycling, the emission of unconverted NOₓ is strongly reduced, less energy is required for compression of the feed gas and less oxygen enriched air needs to be generated, making the concept more efficient.

Particular and preferred aspects of the invention are set out in the accompanying independent and dependent claims. Features from the dependent claims may be combined with features of the independent claims and with features of other dependent claims as appropriate and not merely as explicitly set out in the claims.

Thus, the claims following the detailed description are hereby expressly incorporated into this detailed description, with each claim standing on its own as a separate embodiment of this invention.

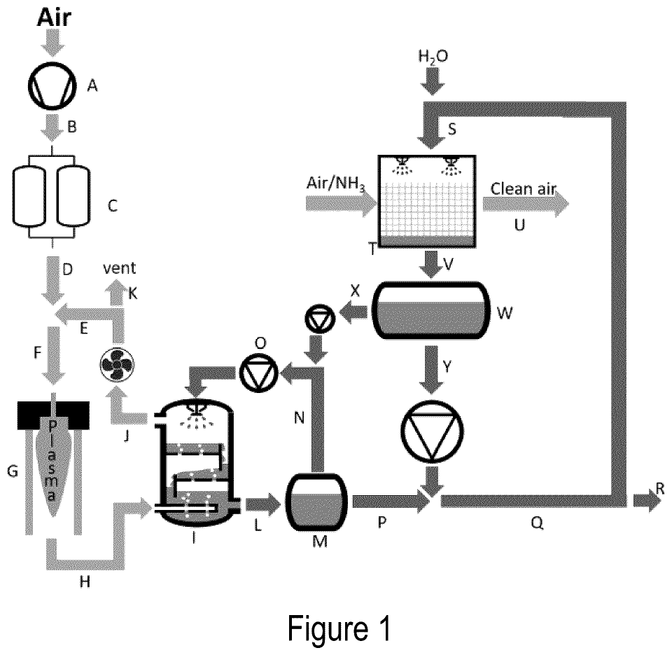

An embodiment of the invention will now be described with reference to FIG. 1. Hereby nitric acid (HNO₃) and possibly nitrous acid (HNO₂) are generated in a series of steps.

First, air is fed to a compressor (A) to achieve an overpressure of 1-11 bar and preferably 3-7 bar.

Next, the compressed air (B) is sent to an air separation unit (C) (e.g. membrane separation or pressure swing adsorption) which generates oxygen enriched air (D) with an O₂/N₂ ratio of 2 -3and preferably 2.3-2.7 and an overpressure of 1-10 bar and preferably 3-8 bar.

Next, the pressurized oxygen enriched air is mixed with the recirculated gas coming from the gas-liquid contactor (E), which comprises N₂, O₂ and possibly NOₓ. The resulting gas mixture (F) has an O₂/N₂ ratio of 0.4-2.5 and is fed to a plasma reactor (G), where it is partly converted to NOₓ (NO₂ and NO), according to eq. 2 and 3 (see above), with a NOₓ concentration of 1-10%.

Next, the NOₓ containing gas (H) is sent to a gas-liquid contactor (I) where the gas is brought into contact with an acidic aqueous solution (pH 1-6), which can comprise NH₃, NH₄⁺, NO₃⁻ and NO₂⁻.

Furthermore, reactions shown in equation 4-15 (see above) take place inside the adsorption column.

Thus combined, Eq. 4-15 result in the conversion of NOₓ into HNO₂ and HNO₃. The ratio of HNO₃/HNO₂ is determined by the pH of the aqueous solution, with a lower pH resulting in a higher selectivity towards HNO₃. The rate limiting reaction is given by Eq. 4. The adsorption column removes >75%, and preferably >90% of NOₓ out of the gas phase. The remaining gas (J), comprising N₂, O₂ and possibly some NOₓ, is recirculated by a fan or compressor (K).

The majority (>75%) (E) of the recirculated gasses is mixed with oxygen enriched air (D) and the mixed stream (F) is fed back to the plasma reactor (G). A small share (<25%) (K) of the recirculated gas is purged to avoid the accumulation of inert or unwanted species such as argon. The liquid stream (L) coming from the gas-liquid contactor (I) is sent to a first buffer tank (M) with an overpressure of 1-10 bar and preferably 3-7 bar.

A share (N) of the aqueous solution in the first buffer tank (M) is fed back to the gas-liquid contactor by a liquid pump (O). Another share (P) of the aqueous solution is mixed with another liquid stream (Q) which operates at atmospheric or near atmospheric pressure (overpressure<1bar). A small share (<10%)® of this liquid stream is drained.

The remaining share(S) can be mixed with a stream of water (>75 wt % H₂O) before it is sent to an air scrubbing unit (T). Inside the air scrubbing unit (T), the aqueous solution (pH 3-6.9) is brought into contact with air containing gaseous NH₃ (1-100 ppm). The ammonia is absorbed into the aqueous solution. This removes >70% and preferably >90% of NH₃ out of the gas phase. The purified gas stream is vented to the atmosphere.

The liquid coming from the gas scrubber (V) is an aqueous solution comprising NH₄⁺, NH₃, NO₃⁻ and NO₂⁻ with a pH of 3-6.9. This liquid is sent to a second buffer tank (W), which operates at atmospheric or near atmospheric pressure (<1 bar overpressure). Some of the liquid (X) from the second buffer tank is pumped to and mixed with the stream (N) coming from the first buffer tank. The mixed stream has an overpressure pressure of 1-10 bar and preferably 3-7 bar or alternatively is at atmospheric or near atmospheric pressure (<1 bar overpressure). Another share of the liquid (Y) coming from the second buffer tank (W) is mixed with another stream (P) coming from the second tank. The mixed stream (Q) operates at atmospheric or near atmospheric pressure (overpressure<1 bar).

Optionally, ammonium nitrate and/or ammonium nitrite can be precipitated out of the liquid product (R) by cooling of the aqueous solution, which lowers the solubility of the dissolved ammonium nitrate and ammonium nitrite. The remaining aqueous solution, which has decreased concentration of dissolved ammonium nitrite and ammonium nitrate (<5 wt %) can be fed back to the air scrubber through stream (Z).

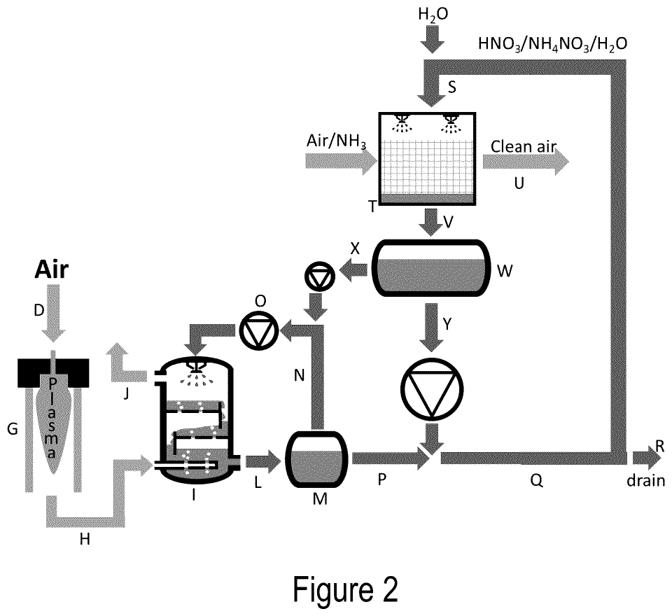

Another embodiment of the invention will now be described with reference to FIG. 2. Hereby nitric acid (HNO₃) and possibly nitrous acid (HNO₂) are generated in a series of steps.

Air is fed to a plasma reactor (G), where it is partly converted to NOₓ (NO₂ and NO), according to eq. 2 and 3 (see above), with a NOₓ concentration of 1-10%.

Next, the NOₓ containing gas (H) is sent to a gas-liquid contactor (I) where the gas is brought into contact with an acidic aqueous solution (pH 1-6), which can comprise NH₃, NH₄⁺, NO₃⁻ and NO₂⁻.

Furthermore, reactions shown in equation 4-15 (see above) take place inside the adsorption.

Thus combined, Eq. 4-15 result in the conversion of NOₓ into HNO₂ and HNO₃. The ratio of HNO₃/HNO₂ is determined by the pH of the aqueous solution, with a lower pH resulting in a higher selectivity towards HNO₃. The rate limiting reaction is given by Eq. 4. The adsorption column removes >75%, and preferably >90% of NOₓ out of the gas phase. The remaining gas (J), comprising N₂, O₂ and possibly some NOₓ, is vented to the atmosphere. The liquid stream (L) coming from the gas-liquid contactor (I) is sent to a first buffer tank (M) at atmospheric or near atmospheric pressure (<0.5 bar overpressure).

A share (N) of the aqueous solution in the first buffer tank (M) is fed back to the gas-liquid contactor by a liquid pump (O). Another share (P) of the aqueous solution is mixed with another liquid stream (Q) which operates at atmospheric or near atmospheric pressure (overpressure<1 bar). A small share (<10%) (R) of this liquid stream is drained. The remaining share(S) can be mixed with a stream of water (>75 wt % H₂O) before it is sent to an air scrubbing unit (T). Inside the air scrubbing unit (T), the aqueous solution (pH 3-6.9) is brought into contact with air containing gaseous NH₃ (1-50 ppm). The ammonia is absorbed into the aqueous solution. This removes >70% and preferably >90% of NH₃ out of the gas phase. The purified gas stream is vented to the atmosphere.

The liquid coming from the gas scrubber (V) is an aqueous solution comprising NH₄⁺, NH₃, NO₃⁻ and NO₂⁻ with a pH of 3-6.9. This liquid is sent to a second buffer tank (W), which operates at atmospheric or near atmospheric pressure (<1 bar overpressure). Some of the liquid (X) from the second buffer tank is pumped to and mixed with the stream (N) coming from the first buffer tank. The mixed stream is at atmospheric or near atmospheric pressure (<1 bar). Another share of the liquid (Y) coming from the second buffer tank (W) is mixed with another stream (P) coming from the second tank. The mixed stream (Q) operates at atmospheric or near atmospheric pressure (overpressure<1 bar).

Optionally, ammonium nitrate and/or ammonium nitrite can be precipitated out of the liquid product (R) by cooling of the aqueous solution, which lowers the solubility of the dissolved ammonium nitrate and ammonium nitrite. The remaining aqueous solution, which has decreased concentration of dissolved ammonium nitrite and ammonium nitrate (21 25 wt %) can be fed back to the air scrubber through stream (Z).

1.-18. (canceled)

19. An apparatus for production of an ammonium nitrate and/or ammonium nitrite solution or solid from a ammonium comprising gas, wherein the apparatus comprises:
i) a NOₓ generator comprising a source of air or oxygen enriched air fluidly connected to a plasma reactor, wherein the plasma reactor is fluidly connected to
ii) a first fluid recirculation unit which is fluidly connected with
iii) a second fluid recirculation unit;
wherein the first fluid recirculation unit comprises:
1) gas-liquid contactor,
2) a gas stream inlet guidance from the NOx generator at the gas-liquid contactor,
3) a buffer unit,
4) a liquid pump between the buffer unit and the gas-liquid contactor and
5) a liquid stream inlet from the second fluid recirculation unit; and
wherein the second fluid recirculation unit comprises:
1) a gas-liquid contactor,
2) a gas stream inlet at the gas-liquid contactor,
3) a buffer unit at atmospheric pressure or near atmospheric pressure (overpressure<1 bar) and
4) a pump between the buffer unit and the gas-liquid contactor.

20. The apparatus for production of an ammonium nitrate and/or ammonium nitrite solution or solid from a ammonium comprising gas according to claim 19, wherein the apparatus comprises:
i) a NOx generator comprising a source of air or oxygen enriched air fluidly connected to a plasma reactor, wherein the plasma reactor is fluidly connected to
ii) a first fluid recirculation unit for producing nitric acid and/or nitrous acid which is fluidly connected with
iii) a second fluid recirculation unit to capture ammonia from an ammonia comprising gas into an aqueous stream comprising nitric acid and/or nitrous acid to produce ammonium nitrate and/or ammonium nitrite;
wherein the first fluid recirculation unit comprises:
1) gas-liquid contactor,
2) a gas stream inlet guidance from the NOx generator at the gas-liquid contactor,
3) a buffer unit for maintaining the aqueous stream of the first fluid recirculation unit slightly acidic pH of 1 to 6,
4) a liquid pump between the buffer unit and the gas-liquid contactor and
5) a liquid stream inlet from the second fluid recirculation unit; and
wherein the second fluid recirculation unit comprises:
1) a gas-liquid contactor,
2) a gas stream inlet at the gas-liquid contactor,
3) a buffer unit for maintaining the aqueous stream of the second fluid recirculation unit slightly acidic pH of 3 to 6.9,
4) an atmospheric pressure or near atmospheric pressure pump between the buffer unit and the gas-liquid contactor.

21. The apparatus according to claim 19, wherein the enriched air source comprises an air intake comprised in or fluidly connected to gas pump, which gas pump is fluidly connected, for instance by a guidance with the air separation unit, which is fluidly connected, for instance by a guidance, to the plasma reactor.

22. The apparatus according to claim 19, wherein the NOx generator comprises an air intake comprised in or fluidly connected to an upstream gas pump, which gas pump is fluidly connected on its downstream side, for instance by a guidance with the air separation unit, which air separation unit is fluidly connected on its downstream side, for instance by a guidance, to the plasma reactor.

23. The apparatus according to claim 19, wherein
1) the NOx generator has a fluid outlet into a fluid inlet of a first fluid recirculation,
2) the first recirculation unit has a fluid outlet into a fluid inlet of a second recirculation unit and
3) the second recirculation unit has a fluid outlet back into a fluid inlet of the first fluid recirculation unit.

24. The apparatus according to claim 19, wherein the NOx generator comprises a plasma reactor and the product of the plasma reactor is passed into the gas-liquid contactor of the first recirculation unit.

25. The apparatus according to claim 19, wherein the NOx generator comprises a plasma reactor operating under an overpressure of 1-10 bar.

26. The apparatus according to claim 19, wherein the NOx generator comprises a plasma reactor fed with a mixture of one or more N2 and/or O2 comprising gas streams with a combined O2/N2 ratio of 2-3, and N2 and O2 comprising recirculated gas coming from a gas outlet of the first fluid recirculation unit (ii) with an O2/N2 ratio of 0.4-2.5, and wherein the mixture fed to the plasma reactor also has an O2/N2 ratio of 0.4-2.5.

27. The apparatus according to claim 26, wherein said mixture has a combined O2/N2 ratio of 2.3-2.7.

28. The apparatus according to claim 27, wherein said mixture is fed to the plasma reactor under pressure of 1-10 bar.

29. The apparatus according to claim 28, wherein said mixture is fed to the plasma reactor under pressure of 3-8 bar.

30. The apparatus according to claim 19, wherein the gas-liquid contactor of the first fluid recirculation unit is an absorption column.

31. The apparatus according to claim 19, wherein the gas-liquid contactor of the second fluid recirculation unit is an air scrubber.

32. The apparatus according to claim 19, wherein the pressure and flowrate of the gas inlet and outlet of the gas-liquid contactor of the first recirculation unit is adapted to maintain the increased pressure of 1-10 bar.

33. The apparatus according to claim 19, wherein the pressure and flowrate of the gas inlet and outlet of the gas-liquid contactor of the first recirculation unit is adapted to maintain an overpressure of 3-7 bar.

34. The apparatus according to claim 19, for continuous production of an ammonium nitrate and/or ammonium nitrite solution or solid from an ammonium comprising gas.

35. The apparatus according to claim 19, for the production of ammonium nitrate and/or ammonium nitrite end product in an aqueous solution.

36. The apparatus according to claim 19, for the production of ammonium nitrate and/or ammonium nitrite end product as a solid.
